(19) United States
(12) Patent Application Publication
(10) Pub. No.: US 2020/0037645 A1
(43) Pub. Date: Feb. 6, 2020

(54) METHOD FOR PREPARATION OF HYPOALLERGENIC PLANT-BASED SUBSTRATE FOR CULTURED AND NON-CULTURED FOOD PRODUCTS

(71) Applicants: Scott Myers, Bakersfield, CA (US); William Myers, Bakersfield, CA (US)

(72) Inventors: Scott Myers, Bakersfield, CA (US); William Myers, Bakersfield, CA (US)

(21) Appl. No.: 16/179,933

(22) Filed: Nov. 3, 2018

Related U.S. Application Data
(60) Provisional application No. 62/713,049, filed on Aug. 1, 2018.

(51) Int. Cl. A23L 25/00; A23L 7/10; A23L 3/00

(52) U.S. Cl. CPC A23L 25/30; A23L 25/40; A23V 2002/00; A23L 3/00; A23L 7/198

(57) ABSTRACT

Method for making a hypoallergenic, plant-based vegan product by combining water with a hypoallergenic-substrate, and a plant-based butter and/or cream including at least one or more of sunflower seed butter and/or coconut cream. The resulting slurry is then subjected to a preservation process. In an alternative method, the resulting slurry is inoculated in order to reduce its pH.

### RELATED APPLICATIONS

The present application claims priority to U.S. Provisional Application Ser. No. 62/713,049 filed on Aug. 1, 2018 and entitled “METHOD AND COMPOSITION FOR HYPOALLERGENIC PLANT-BASED SUBSTRATE FOR CULTURED AND NON-CULTURED FOOD PRODUCTS”, by Myers, et al., the text and figures of each of that application is incorporated by reference into this application in their entireties.

### BACKGROUND

Hypoallergenic is defined as being “below normal” or “slightly” allergenic. Most commercial, plant-based milks and cultured products are made with almonds, cashews or other nuts. Of course, the United States Food and Drug Administration (“FDA”) classifies such nut-based products as nut allergens.

Nearly all nuts have been associated with fatal allergic reactions. A summary of reports from 1996 to 2014 found nut allergy prevalence ranging from 0.05% to almost 5% of the population. Prevalence of individual nut allergies varied significantly by region: Hazelnut was the most common nut allergy in Europe; walnut and cashew in the USA; and Brazil nut, almond and walnut most commonly reported in the UK.

### BRIEF DESCRIPTION OF THE DRAWINGS

Several alternative embodiments will hereinafter be described in conjunction with the appended drawings and figures, wherein like numerals denote like elements, and in which:

FIG. 1 is a flow diagram that depicts one example method for making a hypoallergenic, plant-based vegan product;

FIG. 2 is a flow diagram that depicts one alternative example method for creating a hypoallergenic, plant-based vegan product that is also fermented;

FIG. 3 is a flow diagram that depicts alternative example methods for creating a hypoallergenic, plant-based vegan product based on alternative substrates;

FIG. 4 is a flow diagram that depicts one alternative method wherein various types of hypoallergenic-substrates are combined with water;

FIGS. 5 through 7 are flow diagrams that depict alternative methods for combining water with a hypoallergenic-substrate based on a range of ratios of weights;

FIGS. 8 and 9 are flow diagrams that depict alternative methods for combining water with a plant-based butter and/or cream based on a range of ratios of weights;

FIG. 10 is a flow diagram that depicts alternative example methods for subjecting the hypo-allergenic, vegan products to a preservation process;

FIGS. 11 and 12 are flow diagram that depict alternative methods for inoculating a hypoallergenic, vegan product;

FIG. 13 is a flow diagram that depicts alternative example methods for inoculating a hypoallergenic slurry with a fermentation agent;

FIG. 14 is a flow diagram that depicts yet additional alternative example methods for inoculating a hypoallergenic slurry with a fermentation agent;

FIG. 15 is a flow diagram that depicts yet additional alternative example methods for inoculating a hypoallergenic slurry with a fermentation agent;

FIG. 16 is a flow diagram that depicts yet additional alternative example methods for inoculating a hypoallergenic slurry with a probiotic strain;

FIGS. 17 and 18 are flow diagrams that depict alternative methods for adjusting the pH of a hypoallergenic slurry;

FIGS. 19 and 20 are flow diagrams that depict alternative example methods wherein a prebiotic fiber is added to a fermented hypoallergenic slurry; and

FIGS. 21 and 22 are flow diagrams that depict alternative example methods wherein a plant-based protein is added to a fermented hypoallergenic slurry.

### DETAILED DESCRIPTION

In the interest of clarity, several example alternative methods are described in plain language. Such plain language descriptions of the various steps included in a particular method allow for easier comprehension and a more fluid description of a claimed method and its application. Accordingly, specific method steps are identified by the term “step” followed by a numeric reference to a flow diagram presented in the figures, e.g. (step 5). All such method “steps” are intended to be included in an open-ended enumeration of steps included in a particular claimed method. For example, the phrase “according to this example method, the item is processed using A” is to be given the meaning of “the present method includes step A, which is used to process the item”. All variations of such natural language descriptions of method steps are to be afforded this same open-ended enumeration of a step included in a particular claimed method.

Unless specifically taught to the contrary, method steps are interchangeable and specific sequences may be varied according to various alternatives contemplated. Accordingly, the claims are to be construed within such structure. Further, unless specifically taught to the contrary, method steps that include the phrase “ . . . comprises at least one or more of A, B, and/or C . . . ” means that the method step is to include every combination and permutation of the enumerated elements such as “only A”, “only B”, “only C”, “A and B, but not C”, “B and C, but not A”, “A and C, but not B”, and “A and B and C”. This same claim structure is also intended to be open-ended and any such combination of the enumerated elements together with a non-enumerated element, e.g. “A and D, but not B and not C”, is to fall within the scope of the claim. Given the open-ended intent of this claim language, the addition of a second element, including an additional of an enumerated element such as “2 of A”, is to be included in the scope of such claim. This same intended claim structure is also applicable to apparatus and system claims.

It should likewise be appreciated that the method steps herein described are useful in manufacture of a composition of matter, which various embodiments are claimed as well. The composition of matter is evident from the method of production and from the claims hereto appended. When a composition is formed for a cultured product, there will remain a latent fermentation agent. A latent fermentation agent is defined herein as a fermentation agent that is substantially not active at lower pH levels. The stated combinations are, contrary to ordinary fermentation of dairy and plant based matter, less likely to post acidify.

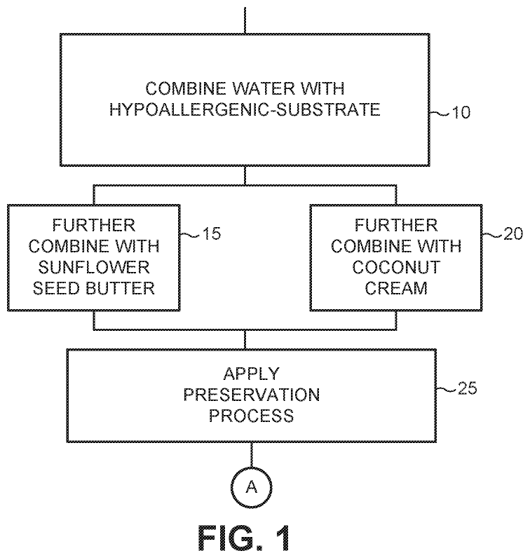

FIG. 1 is a flow diagram that depicts one example method for making a hypoallergenic, plant-based vegan product. According to this example method, a hypoallergenic, plant-based vegan product is made by creating a hypoallergenic-slurry by combining water with a hypoallergenic substrate (step 10). In continuation of creating the hypoallergenic-slurry, the water is further combined with a sunflower seed butter (step 15). In one alternative method, the hypoallergenic-slurry is created by further combining the water with a coconut cream (step 20). In this example method, the hypoallergenic-slurry is then subject to a preservation process (step 25). It should likewise be appreciated that, according to various alternative example methods, a stabilizer is also added to the hypoallergenic-slurry in order to help retard separation of a plant-based butter and/or cream from the water and/or the hypoallergenic substrate.

It should be appreciated that the hypoallergenic-plant-based vegan product created by the method heretofore described is useful as a base for many varying products, including, for example, a salad dressing. It should be appreciated that any such illustrative use cases, including application of the hypoallergenic, plant-based vegan product as a base for a salad dressing, is not intended to limit the scope of the claims appended hereto.

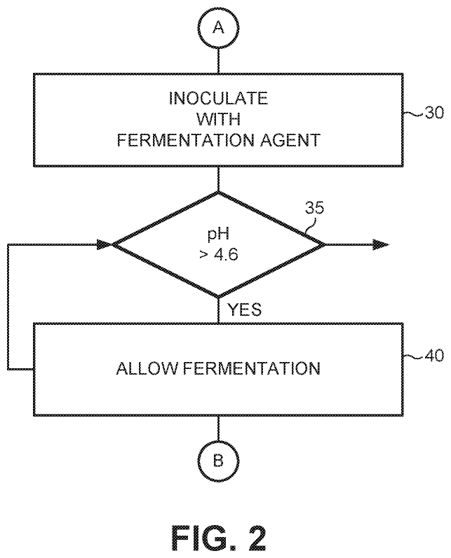

FIG. 2 is a flow diagram that depicts one alternative example method for creating a hypoallergenic, plant-based vegan product that is also fermented. The hypoallergenic, plant-based vegan product heretofore described is also useful as a basis for other products, including cultured substitutes for dairy products. According to one alternative example method, making a hypoallergenic, plant-based vegan product further comprises an included step for inoculating the hypoallergenic-slurry with a fermentation agent (step 30). Once the hypoallergenic-slurry is inoculated with the fermentation agent, it is allowed to ferment (step 40) until it reaches a pH of 4.6 or lower (step 35). Surprisingly, there exists a synergy in the stated formulation of the hypoallergenic-slurry. The unique combination of the plant-based butter and/or cream and the ancient grains and/or pseudo cereals that allows fermentation at a faster rate than expected and achievement of a lower pH than ordinarily expected or when cultured individually.

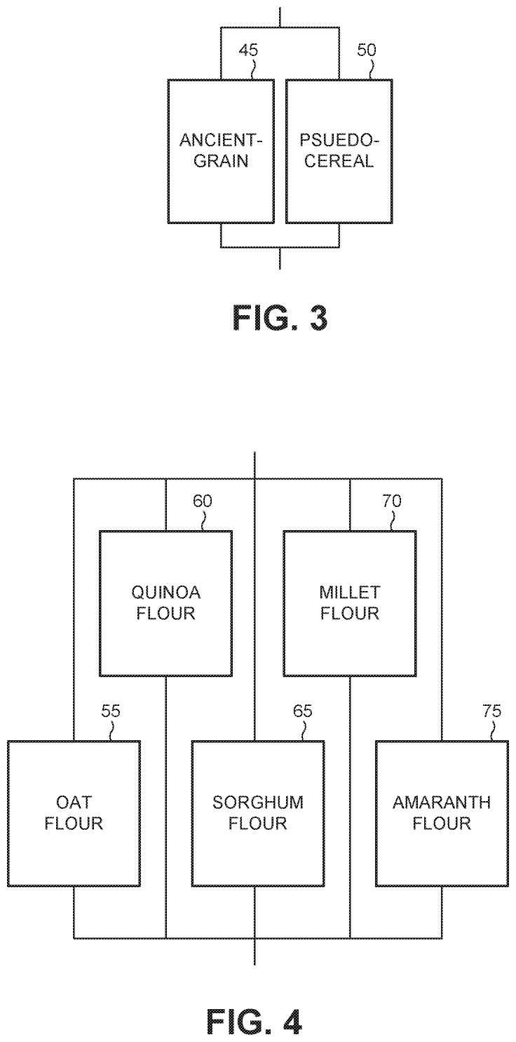

FIG. 3 is a flow diagram that depicts alternative example methods for creating a hypoallergenic, plant-based vegan product based on alternative substrates. The term hypoallergenic ‘plant milk’ or ‘non-dairy milk’ refers to a liquid that resembles dairy milk but is made from hypoallergenic plant-based ingredients. Said hypoallergenic plant-based substrate comprises at least one or more of proteins, fats, carbohydrates, vitamins and/or minerals. It should be appreciated that dairy allergens, lactose, cholesterol, soy and/or tree nut allergens are not included. According to one alternative example embodiment, the method for creating a hypoallergenic, plant-based vegan product comprises a step wherein combining the water with a hypoallergenic-substrate comprises combining the water with an ancient-grain (step 45). In yet another alternative example embodiment, the method for creating a hypoallergenic, plant-based vegan product comprises a step wherein combining the water with a hypoallergenic-substrate comprises combining the water with a pseudo-cereal (step 50).

In these alternative example embodiments, the hypoallergenic, plant-based vegan product provides a substrate suitable for use as a base in other various food products, including salad dressing. Likewise, because the hypoallergenic-substrate includes the carbohydrate content, it is suitable for use as a base for a fermentation process. Accordingly, hypoallergenic, plant-based vegan product, according to various illustrative use cases, is used to create non-dairy alternatives to products such as yogurt. It should be appreciated that, even though yogurt is a common derivative of a product produced according to the present method, is not intended that this illustrative use case limit the scope of the claims appended hereto.

FIG. 4 is a flow diagram that depicts one alternative method wherein various types of hypoallergenic-substrates are combined with water. According to one alternative example method, a step is included for combining an oat flour (step 55) with water. In yet another alternative example embodiment, an included step provides for combining quinoa flour (step 60) with water. In yet another alternative method, sorghum flour is combined with water (step 65) in an included step. Millet flour (step 70) is used in yet an alternative included step for combining water with a hypoallergenic-substrate Amaranth flour (step 75) is used in yet another alternative included step for combining water with a hypoallergenic-substrate. It should be appreciated that these various types of alternative ingredients, used in a corresponding included method steps, provide a base that is suitable for fermentation or as a base for other non-dairy, vegan products.

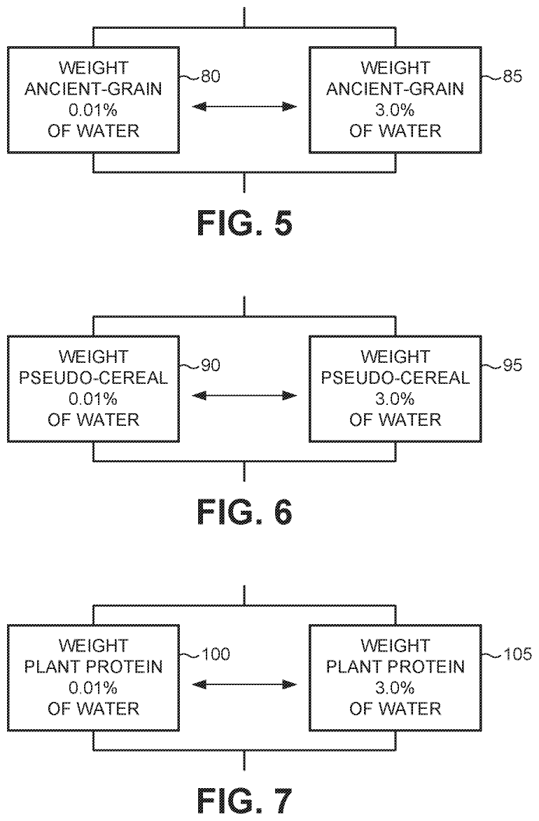

FIGS. 5 through 7 are flow diagrams that depict alternative methods for combining water with a hypoallergenic-substrate based on a range of ratios of weights. In one alternative example embodiment, combining water with a hypoallergenic-substrate comprises combining with the water an ancient grain in a ratio by weight wherein the weight of the ancient-grain is at a minimum of 0.01% of the water (step 80). Various ratios beginning at 0.01% and running through 3.0% of the weight of water in the weight of an ancient-grain (step 85) is to be included in the method claims hereto appended.

In yet another alternative example embodiment, combining water with a hypoallergenic-substrate comprises combining with the water a pseudo-cereal in a ratio by weight wherein the weight of the pseudo-cereal is at a minimum of 0.01% of the water (step 90). Various ratios beginning at 0.01% and running through 3.0% of the weight of water in the weight of a pseudo-cereal (step 95) is to be included in the method claims hereto appended.

According to yet another alternative example method, the hypoallergenic-substrate comprises a plant-based protein. Accordingly, one alternative method provides for combining water with a plant-based protein in a ratio by weight wherein the weight of the plant-based protein is at a minimum of 0.01% of the water (step 100). Various ratios beginning at 0.01% and running through 3.0% of the weight of water in the weight of a plant-based protein (step 105) is to be included in the method claims hereto appended.

It should be appreciated that another useful application of such hypoallergenic, plant-based vegan includes addition of a plant-based protein to the slurry. According to yet another alternative method, an additional included step provides for adding a soluble fiber to the hypoallergenic-slurry. In one alternative method, the included step comprises adding at least 0.01% (weight by weight) of plant-based protein to the hypoallergenic-slurry. In yet another alternative method, the included step comprises adding up to 3.0% (weight by weight) of plant-based protein to the hypoallergenic-slurry. It should be appreciated that another useful application of such hypoallergenic, plant-based vegan includes addition of a soluble fiber to the slurry.

According to yet another alternative method, an additional included step provides for adding a soluble fiber to the hypoallergenic-slurry. In one alternative method, the included step comprises adding at least 0.01% (weight by weight) of soluble fiber to the hypoallergenic-slurry. In yet another alternative method, the included step comprises adding up to 3.0% (weight by weight) of soluble fiber to the hypoallergenic-slurry.

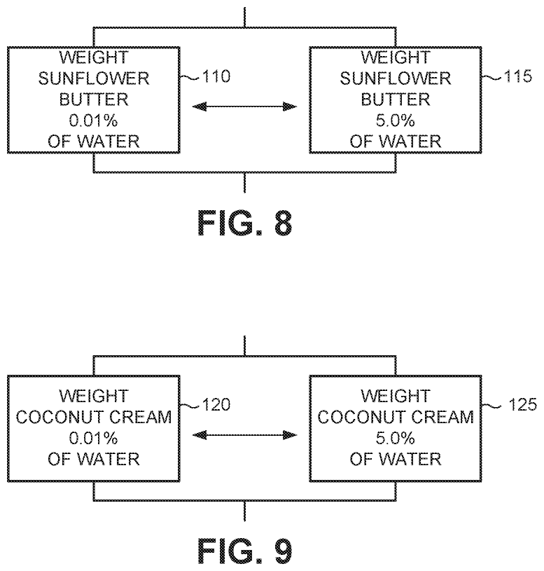

FIGS. 8 and 9 are flow diagrams that depict alternative methods for combining water with a plant-based butter based on a range of ratios of weights. One alternative method provides for combining water with sunflower seed butter in a ratio by weight wherein the weight of the sunflower seed butter is at a minimum of 0.01% of the water (step 110). Various ratios beginning at 0.01% and running through 5.0% of the weight of water in the weight of a sunflower seed butter (step 115) is to be included in the method claims hereto appended. According to yet another variation of the present method which is not depicted in the figures, various ratios beginning at 4.9% (in an included method step) and running through 10.0% (in an included method step) of the weight of water in the weight of a sunflower seed butter (in an included method step) is to be included in the method claims hereto appended. It should be appreciated that, although a preferred method provides for adding an amount of sunflower seed butter up to 5% of the weight of the water, other variations of the present method are acceptable where the amount of sunflower seed butter combined with the water in an amount of up to 10% of the weight of the water. It should be appreciated that, in these variations of the method, much more stabilizer is required, relative to the preferred methods, to help retard the separation of the sunflower seed butter from the water.

One alternative method provides for combining water with coconut cream in a ratio by weight wherein the weight of the coconut cream is at a minimum of 0.01% of the water (step 120). Various ratios beginning at 0.01% and running through 5.0% of the weight of water in the weight of a coconut cream (step 125) is to be included in the method claims hereto appended. According to yet another variation of the present method which is not depicted in the figures, various ratios beginning at 4.9% (in an included method step) and running through 10.0% (in an included method step) of the weight of water in the weight of a coconut cream (in an included method step) is to be included in the method claims hereto appended. It should be appreciated that, although a preferred method provides for adding an amount of coconut cream up to 5% of the weight of the water, other variations of the present method are acceptable where the amount of coconut cream combined with the water in an amount of up to 10% of the weight of the water. It should be appreciated that, in these variations of the method, much more stabilizer is required, relative to the preferred methods, to help retard the separation of the coconut cream from the water.

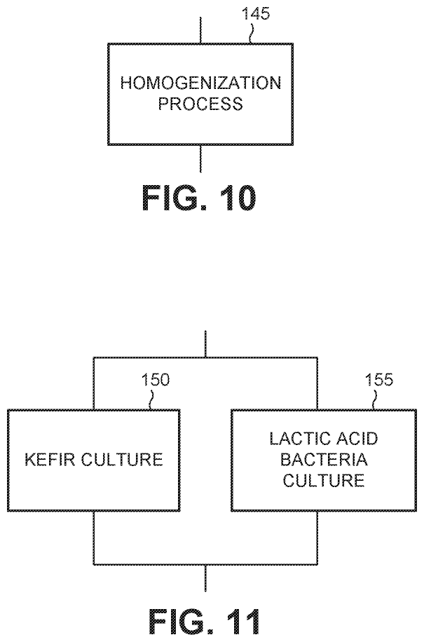

FIG. 10 is a flow diagram that depicts alternative example methods for subjecting the hypo-allergenic, vegan products to a preservation process. According to one alternative example method, preservation is accomplished by an included method step for subjecting the products to a pasteurization process [(step 140)]. In yet another alternative example method, preservation is accomplished by a method step for subjecting the product to a homogenization process (step 145).

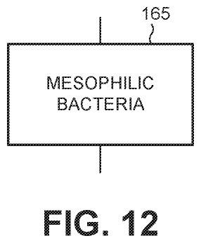

FIGS. 11 and 12 are flow diagram that depict alternative methods for inoculating a hypoallergenic, vegan product. It has been discovered that a hypoallergenic, plant-based substrate can be fermented using lactic acid and other mesophilic bacteria used for making yogurt, buttermilk and kefir. It has also been discovered that this plant-based substrate can be fermented without the specific addition of a monosaccharide or disaccharide. Accordingly, one alternative example method provides for inoculating the hypoallergenic-slurry with the kefir culture (step 150). And in yet another alternative example method step, the hypoallergenic slurry is inoculated with a lactic acid bacteria culture (step 155). And in yet another alternative example method, the hypoallergenic slurry is inoculated with a mesophilic bacteria culture (step 165).

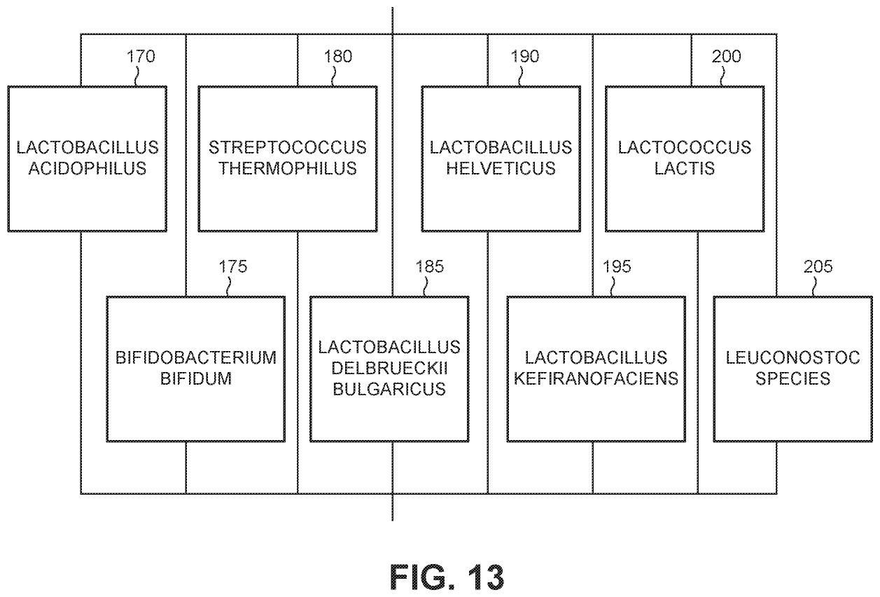

FIG. 13 is a flow diagram that depicts alternative example methods for inoculating a hypoallergenic slurry with a fermentation agent. According to these various alternative example methods, the included step of inoculating a hypoallergenic slurry comprises inoculating a hypoallergenic slurry with a fermentation agent including at least one or more of Lactobacillus acidophilus (step 170), Bifidobacterium bifidum (step 175), Streptococcus thermophilus (step 180), Lactobacillus delbrueckii bulgaricus (step 185), Lactobacillus helveticus (step 190), Lactobacillus kefiranofaciens (step 195), Lactococcus lactis (step 200), Leuconostoc species (step 205), and/or Lactobacillus plantarum, which is not depicted in the figure but is included in one alternative method step[(step 207)].

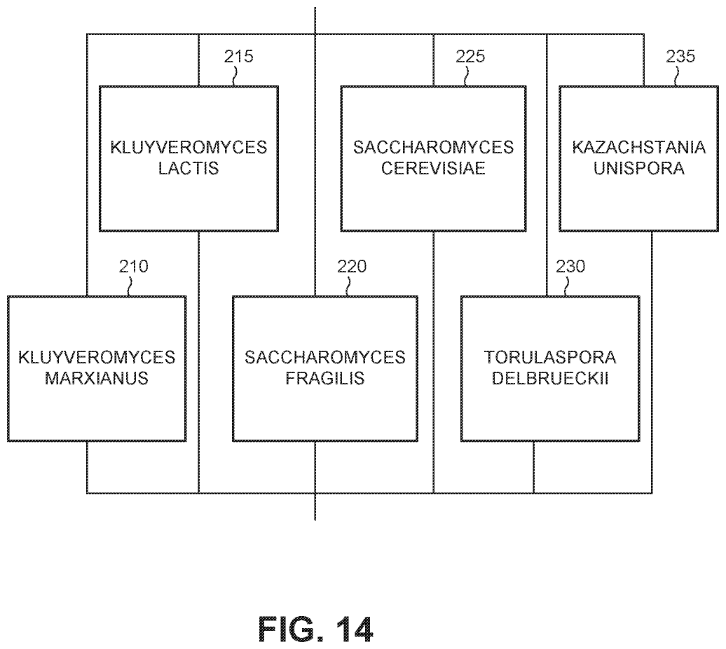

FIG. 14 is a flow diagram that depicts yet additional alternative example methods for inoculating a hypoallergenic slurry with a fermentation agent. According to these various alternative example methods, the included step of inoculating a hypoallergenic slurry comprises inoculating a hypoallergenic slurry with a fermentation agent including at least one or more of Kluyveromyces marxianus (step 210), Kluyveromyces lactis (step 215), Saccharomyces fragilis (step 220), Saccharomyces cerevisiae (step 225), Torulaspora delbrueckii (step 230), and/or Kazachstania unispora (step 235).

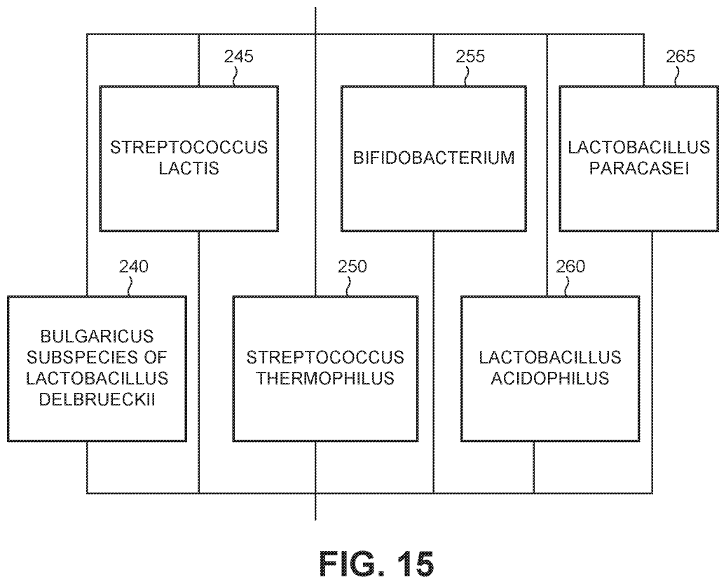

FIG. 15 is a flow diagram that depicts yet additional alternative example methods for inoculating a hypoallergenic slurry with a fermentation agent. According to these various alternative example methods, the included step of inoculating a hypoallergenic slurry comprises inoculating a hypoallergenic slurry with a fermentation agent including at least one or more of Lactobacillus delbrueckii bulgaricus (step 240), Streptococcus lactis (step 245), Streptococcus thermophilus (step 250), Bifidobacterium (step 255), Lactobacillus acidophilus (step 260), Lactobacillus paracasei (step 265) and/or Lactobacillus plantarum, which is not depicted in the figure but in an included step in one alternative example method.

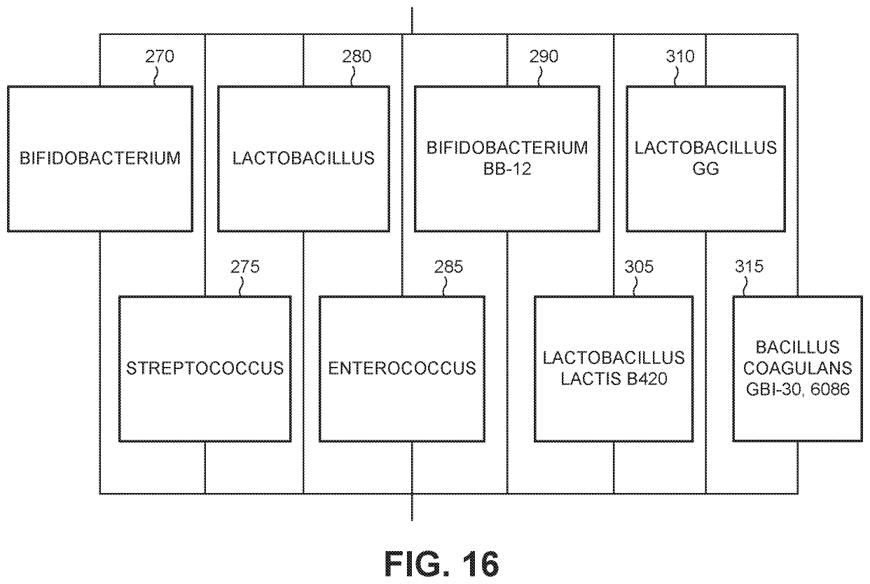

FIG. 16 is a flow diagram that depicts yet additional alternative example methods for inoculating a hypoallergenic slurry with a probiotic strain. According to these various alternative example methods, the included step of inoculating a hypoallergenic slurry comprises inoculating a hypoallergenic slurry with a probiotic strain including at least one or more of Bifidobacterium (step 270), Streptococcus (step 275), Lactobacillus (step 280), Enterococcus (step 285), Bifidobacterium BB-12 (step 290), Lactobacillus lactis B420 (step 305), Lactobacillus GG (step 310), Bacillus coagulans GBI-30, 6086 (step 315), and/or Bidifobacterium infantis 35624 which is not depicted in the figure but is an included step in one alternative example method.

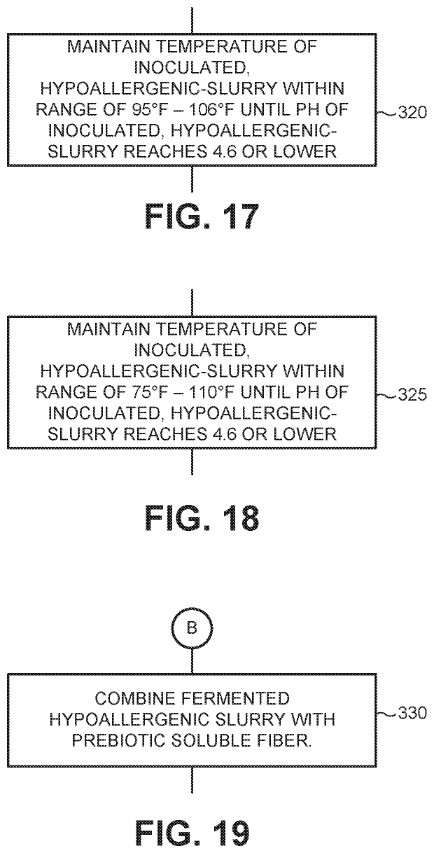

FIGS. 17 and 18 are flow diagrams that depict alternative methods for adjusting the pH of a hypoallergenic slurry. According to one alternative example method, a step is included for maintaining the temperature of the hypoallergenic slurry within a range substantially between 95° F. and 106° F. until the pH of the hypoallergenic slurry reaches 4.6 or lower (step 320). According yet another alternative example method, a step is included for maintaining the temperature of the hypoallergenic slurry within a range substantially between 75° F. and 110° F. until the pH of the hypoallergenic slurry reaches 4.6 or lower (Step 325).

According to other various example methods that are not depicted in the figures, a step is included for maintaining the temperature of the hypoallergenic slurry within a range substantially between 95° F. and 106° F. until the pH of the hypoallergenic slurry reaches a value of 3.9 through 4.6, inclusive of the end points of this range (step 322). According yet another alternative example method, a step is included for maintaining the temperature of the hypoallergenic slurry within a range substantially between 75° F. and 110° F. until the pH of the hypoallergenic slurry reaches a value of 3.9 through 4.6, inclusive of the end points of this range (step 327).

According to other various example methods, a step is included for maintaining the temperature of the hypoallergenic slurry within a range substantially between 95° F. and 106° F. for an amount of time between 3.9 and 8.1 hours (step 323). In another alternative method, a step is included for maintaining the temperature of the hypoallergenic slurry within a range substantially between 75° F. and 110° F. for an amount of time between 3.9 and 8.1 hours (step 328).

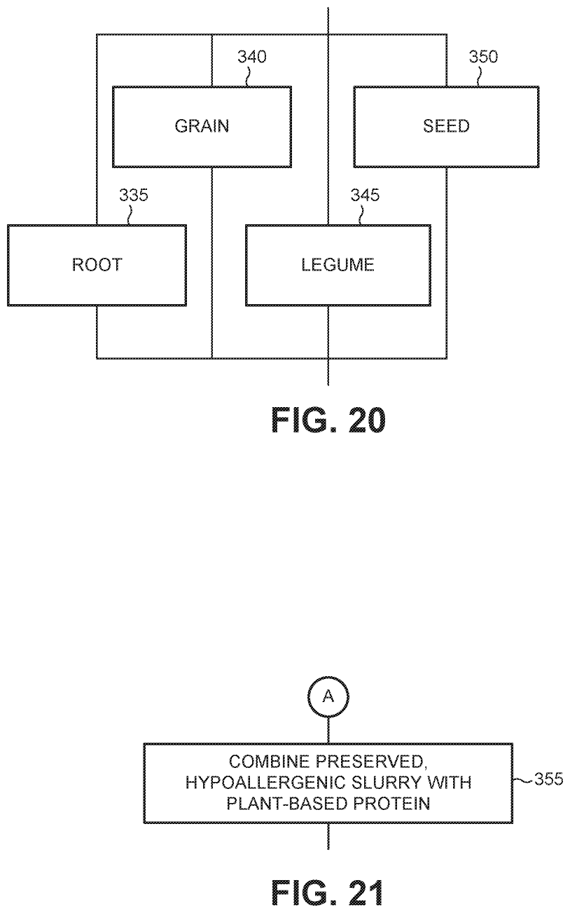

FIGS. 19 and 20 are flow diagrams that depict alternative example methods wherein a prebiotic fiber is added to a fermented hypoallergenic slurry. It should be appreciated that, according to this alternative example method, an additional included step provides for combining a prebiotic soluble fiber with a fermented hypoallergenic slurry (step 330). According to various alternative example methods, the included step for combining a prebiotic soluble fiber with the fermented hypoallergenic slurry comprises combining at least one or more of a root (step 335), a grain (step 340), a legume (step 345) and/or a seed (step 350).

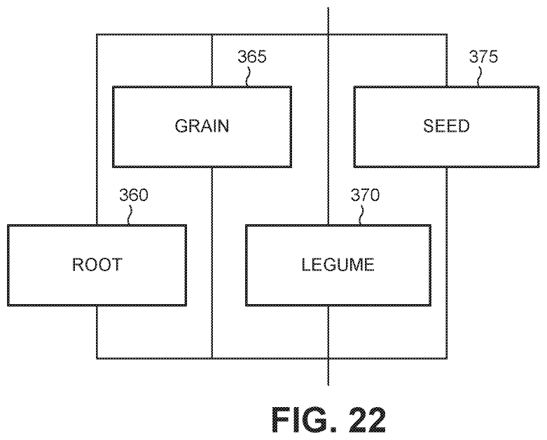

FIGS. 21 and 22 are flow diagrams that depict alternative example methods wherein a plant-based protein is added to a fermented hypoallergenic slurry. It should be appreciated that, according to this alternative example method, an additional included step provides for combining a plant-based protein with a fermented hypoallergenic slurry (step 355). According to various alternative example methods, the included step for combining a plant-based protein with the fermented hypoallergenic slurry comprises combining at least one or more of a root (step 360), a grain (step 365), a legume (step 370) and/or a seed (step 375).

While the present method and composition has been described in terms of several alternative and exemplary embodiments, it is contemplated that alternatives, modifications, permutations, and equivalents thereof will become apparent to those skilled in the art upon a reading of the specification and study of the drawings. It is therefore intended that the true spirit and scope of the claims appended hereto include all such alternatives, modifications, permutations, and equivalents.

What is claimed is:

1. A method for making a hypoallergenic, plant-based vegan product:
creating a hypoallergenic-slurry by combining water, a hypoallergenic-substrate, and a plant-based butter and/or cream comprising at least one or more of sunflower seed butter and/or coconut cream; and
subjecting the hypoallergenic-slurry to a preservation process.

2. Claim 1 further comprising:
inoculating the hypoallergenic-slurry with a fermentation agent; and
allowing the inoculated, hypoallergenic-slurry to ferment until it reaches a pH of 4.6 or lower.

3. Claim 1 further comprising adding at least 0.01% (of the weight of the water) of a soluble fiber to the hypoallergenic-slurry.

4. Claim 1 further comprising adding up to 3.0% (of the weight of the water) of a soluble fiber to the hypoallergenic-slurry.

5. Claim 1 further comprising adding at least 0.01% (of the weight of the water) of a plant-based protein to the hypoallergenic-slurry.

6. Claim 1 further comprising adding up to 3.0% (of the weight of the water) of a plant-based protein to the hypoallergenic-slurry.

7. The method of claim 1 wherein combining water with a hypoallergenic-substrate comprises combining water with at least one or more of an ancient grain and/or a pseudo-cereal.

8. The method of claim 1 wherein combining water with a hypoallergenic-substrate comprises combining water with at least one or more of oat flour, quinoa flour, sorghum flour, millet flour and/or amaranth flour.

9. The method of claim 1 wherein combining water with a hypoallergenic-substrate comprises combining water with an ancient grain in a ratio by weight of said ancient grain being of 0.01% to 3.0% of the weight of the water.

10. The method of claim 1 wherein combining water with a hypoallergenic-substrate comprises combining water with a pseudo-cereal in a ratio by weight of said pseudo-cereal being of 0.01% to 3.0% of the weight of the water.

11. The method of claim 1 wherein combining water with a hypoallergenic-substrate comprises combining water with a plant-based protein in a ratio by weight of said plant-based protein being of 0.01% to 3.0% of the weight of the water.

12. The method of claim 1 wherein combining water with a plant-based butter comprises combining water with a sunflower seed butter in a ratio by weight of said sunflower seed butter being of 0.01% to 5.0% of the weight of the water.

13. The method of claim 1 wherein combining water with a plant-based butter comprises combining water with a sunflower seed butter in a ratio by weight of said sunflower seed butter being of 4.9% to 10.0% of the weight of the water and adding a stabilizing agent to the hypoallergenic-slurry.

14. The method of claim 1 wherein combining water with a plant-based cream comprises combining water with a coconut cream in a ratio by weight of said coconut cream being of 0.01% to 5.0% of the weight of the water.

15. The method of claim 1 wherein combining water with a plant-based cream comprises combining water with a coconut cream in a ratio by weight of said coconut cream being of 4.9% to 10.0% of the weight of the water and adding a stabilizing agent to the hypoallergenic-slurry.

16. The method of claim 1 wherein the preservation process comprises at least one or more of a pasteurization process and/or a homogenization process.

17. The method of claim 2 wherein inoculating the hypoallergenic-slurry with a fermentation agent comprises inoculating the hypoallergenic-slurry with at least one or more of a kefir culture and/or lactic acid bacteria culture.

18. The method of claim 2 wherein inoculating the hypoallergenic-slurry with a fermentation agent comprises inoculating the hypoallergenic-slurry with at least one or more of a lactic acid bacteria culture and/or mesophilic bacteria culture.

19. The method of claim 2 wherein inoculating the hypoallergenic-slurry with a fermentation agent comprises inoculating the hypoallergenic-slurry with at least one or more of Lactobacillus acidophilus, Bifidobacterium bifidum, Streptococcus thermophilus, Lactobacillus delbrueckii bulgaricus, Lactobacillus helveticus, Lactobacillus kefiranofaciens, Lactococcus lactic, Leuconostoc species, Lactobacillus paracasei and/or Lactobacillus plantarum.

20. The method of claim 2 wherein inoculating the hypoallergenic-slurry with a fermentation agent comprises inoculating the hypoallergenic-slurry with at least one or more of Kluyveromyces marxianus, Kiuyveromyces lactic, Saccharomyces fragilis, Saccharomyces cerevisiae, Torulaspora delbrueckii, and/or Kazachstania unispora.

21. The method of claim 2 wherein inoculating the hypoallergenic-slurry with a fermentation agent comprises inoculating the hypoallergenic-slurry with at least one or more of Lactobacillus delbrueckii bulgaricus, Streptococcus lactis, Streptococcus thermophilus, Bifidobacterium, Lactobacillus acidophilus, Lactobacillus paracasei, and/or Lactobacillus plantarum.

22. The method of claim 2 wherein inoculating the hypoallergenic-slurry with a fermentation agent comprises inoculating the hypoallergenic-slurry with a probiotic strain comprising at least one or more of a Bifidobacterium, Streptococcus, Lactobacillus, Enterococcus, Bifidobacterium BB-12, Bidifobacterium infantis 35624, Lactobacillus lactis B420, Lactobacillus GG, and/or Bacillus coagulans GBI-30, 6086.

23. The method of claim 2 wherein allowing inoculated, hypoallergenic-slurry to ferment comprises:
maintaining the temperature of the inoculated, hypoallergenic-slurry within a range of 95° F.-106° F. until the pH of the inoculated, hypoallergenic-slurry reaches 4.6 or lower.

24. The method of claim 2 wherein allowing inoculated, hypoallergenic-slurry to ferment comprises:
maintaining the temperature of the inoculated, hypoallergenic-slurry within a range of 75° F.-110° F. until the pH of the inoculated, hypoallergenic-slurry reaches 4.6 or lower.

25. The method of claim 2 wherein allowing inoculated, hypoallergenic-slurry to ferment comprises:
maintaining the temperature of the inoculated, hypoallergenic-slurry within a range of 95° F.-106° F. until the pH of the inoculated, hypoallergenic-slurry reaches 3.9 through 4.6 inclusive of end values of the range.

26. The method of claim 2 wherein allowing inoculated, hypoallergenic-slurry to ferment comprises:
maintaining the temperature of the inoculated, hypoallergenic-slurry within a range of 75° F.-110° F. until the pH of the inoculated, hypoallergenic-slurry reaches value of 3.9 through 4.6 inclusive of end values of the range.

27. The method of claim 2 wherein allowing inoculated, hypoallergenic-slurry to ferment comprises:
maintaining the temperature of the inoculated, hypoallergenic-slurry within a range of 95° F.-106° F. for a period of 3.9 to 8.1 hours.

28. The method of claim 2 wherein allowing inoculated, hypoallergenic-slurry to ferment comprises:
maintaining the temperature of the inoculated, hypoallergenic-slurry within a range of 75° F.-110° F. for a period of 3.9 to 8.1 hours.

29. The method of claim 1 further comprising combining the fermented hypoallergenic slurry with a prebiotic soluble fiber.

30. The method of claim 25 wherein combining the fermented hypoallergenic slurry with a prebiotic soluble fiber comprises combining the fermented hypoallergenic slurry with at least one or more of a root, a grain, a legume, a seed powder and/or a seed extract.

31. The method of claim 1 further comprising combining the preserved, hypoallergenic slurry with a plant-based protein.

32. The method of claim 31 wherein combining the preserved, hypoallergenic slurry with a plant-based protein comprises combining the preserved, hypoallergenic slurry with at least one or more of root, grain, legume, a seed powder and/or a seed extract.
